(19) United States
(12) Patent Application Publication
(10) Pub. No.: US 2024/0386449 A1
(43) Pub. Date: Nov. 21, 2024

(54) Verifying the authenticity of a manufactured product

(71) Applicant: DigiCert, Inc., Lehi, UT (US)

(72) Inventors: Ganapathi Murali, Bengaluru (IN); Avesta Hojjati, Austin, TX (US)

(73) Assignee: DigiCert, Inc., Lehi, UT (US)

(21) Appl. No.: 18/788,914

(22) Filed: Jul. 30, 2024

Related U.S. Application Data
(63) Continuation-in-part of application No. 17/655,287, filed on Mar. 17, 2022.

(30) Foreign Application Priority Data
Jun. 14, 2024 (IN) 202441046016

(51) Int. Cl. G06Q 30/018; G06V 30/224

(52) U.S. Cl. CPC G06Q 30/0185; G06V 30/224

(57) ABSTRACT

Systems and methods for verifying the authenticity of a manufactured product are provided. In one implementation, a method includes a step of receiving a scanned image of an encoded security seal printed on a print medium associated with a package configured for protecting a manufactured product. The method also includes a step of extracting a set of coded information from the scanned image of the encoded security seal. In response to analyzing the set of coded information, the method further includes a step of determining whether the manufactured product is authentic.

### CROSS-REFERENCE TO RELATED APPLICATION

The present application is a Continuation-in-Part (CIP) of application Ser. No. 17/655,287, filed Mar. 17, 2022, entitled “AUTHENTICATION OF SECURITY SEALS USING DYNAMIC AUTHENTICATION INFORMATION,” the contents of which are incorporated by reference herein.

### FIELD OF THE DISCLOSURE

The present disclosure relates generally to network security and authentication systems. More particularly, the present disclosure relates to systems and methods for verifying the authenticity of a manufactured product.

### BACKGROUND

Counterfeiting affects a wide range of products across various industries. Some products that are commonly the target of counterfeiting include pharmaceuticals, electronics, luxury items (e.g., handbags, clothing, shoes, accessories, watches, jewelry, etc.), cosmetics, machine parts, packaged foods (e.g., baby food), toys, video games, software, household appliances, sporting goods, etc. According to some estimates, counterfeit products cost the global economy over $500 billion a year. Counterfeit products not only cause economic losses to legitimate businesses, but they can also pose serious health and safety risks to consumers, particularly in the case of pharmaceuticals, food, beverages, and automotive parts. For the sake of consumer confidence, it may be important to the consumer to verify the authenticity of a product or manufacturer. By properly verifying authenticity, the consumer can then trust that a product is not counterfeit.

### BRIEF SUMMARY

The present disclosure relates to systems and methods for verifying the authenticity of manufactured products and the packaging used for protecting these products. In various embodiments, the present disclosure includes a) methods having the above-mentioned steps, b) processing devices configured to implement the above-mentioned steps, c) cloud services configured to implement the above-mentioned steps, and d) non-transitory computer-readable media storing instructions for programming one or more processors to execute the above-mentioned steps.

According to one implementation, a method includes the step of receiving a scanned image of an encoded security seal printed on a print medium associated with a package configured for protecting a manufactured product. Also, the method includes a step of extracting a set of coded information from the scanned image of the encoded security seal. In response to analyzing the set of coded information, the method further includes a step of determining whether the manufactured product is authentic.

In some embodiments, the encoded security seal may include one or more visible attributes and one or more hidden attributes. The step of extracting the set of coded information may include obtaining the set of coded information from at least the one or more hidden attributes. The one or more hidden attributes may include a) a set of angles associated with lines or text in the visible attributes, b) a depth map obtained by a depth sensor, and/or c) three dimensional system placement features. In some cases, the one or more hidden attributes may include a hologram and/or a steganographic image. The one or more visible attributes may include added or manipulated pixels and/or imperfections in one or more of an image, logo, text, and border associated with the visible attributes. The one or more visible attributes may further include arbitrary noise intended to deceive a counterfeiter. The one or more visible attributes may include a barcode or QR code configured to reference a trusted web address. The one or more hidden attributes may be hidden within the barcode or QR code.

According to some implementations, the scanned image may be obtained by a camera of a user device associated with a consumer who has purchased the manufactured product. The step of receiving the scanned image may be performed by a trust entity in communication with the user device. The user device may be a mobile device, wherein an app or Software Development Kit (SDK) running on the mobile device may be configured to perform the steps of receiving, extracting, and determining.

The scanned image, for example, may be obtained by a device associated with a distributor or retailer in a supply chain between a manufacturer of the manufactured product and a consumer of the manufactured product. The method may further include a step of storing one or more sets of encoded information in a blockchain format and determine authenticity of the product throughout the supply chain. The method may also record multiple sets of coded information extracted from scanned images of multiple encoded security seals printed in association with multiple packages, wherein each set of coded information includes a non-repeatable nonce. Also, determining that the manufactured product is authentic may include observing that the respective non-repeatable nonce has not been previously replayed.

In response to determining whether the manufactured product is authentic, the method may further include a step of providing an indication to a consumer of the manufactured product as to whether the manufactured product is authentic or counterfeit. The print medium, for instance, may be a) an outer surface of the package and/or b) a label attached to the outer surface of the package. Alternatively, the print medium may be a) a piece of paper or card placed inside the package during manufacturing and/or b) an inside surface of the package.

The set of coded information may include one or more of validity information, manufacturer information, manufacturing date, manufacturing location, product information, product serial number, product expiration date, and expiration date of a certificate associated with the manufacturer or product. The set of coded information may also include encrypted information using Rivest-Shamir-Adleman (RSA) cryptography. The product, for example, may include pharmaceuticals, packaged food, electronics, luxury items, watches, jewelry, cosmetics, machine parts, software, video games, machine parts, household appliances, and/or sports equipment.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram illustrating a product authentication system, according to various embodiments of the present disclosure.

FIG. 2 is a diagram showing an isometric view of a package that protects a manufactured product, according to various embodiments.

FIG. 3 is a diagram illustrating a security seal associated with a package, according to various embodiments.

FIG. 4 is a block diagram illustrating computing components of the trusted entity shown in FIG. 1, according to various embodiments.

FIG. 5 is a block diagram illustrating computing components of the user device shown in FIG. 1, according to various embodiments.

FIG. 6 is a flow diagram illustrating a method for verifying the authenticity of a manufactured product, according to various embodiments.

### DETAILED DESCRIPTION

The present disclosure relates to digital certificates and security seals used for giving consumers confidence that the products they purchase are legitimate, authentic products and not counterfeits. The present disclosure also relates to systems and methods for encrypting manufacturing and product information into security seals and applying the security seals to packaging associated with the manufactured products. In one example, a consumer may scan a security seal printed on the outside of a package using a dedicated app on his or her phone. The app may be configured to decode information that may be hidden in the image of the security seal or may forward a captured image to a Certificate Authority (CA), trusted entity, or management system, where the security seal can be analyzed. The parent application, to which the present application claims priority, is directed to security seals that may be viewed online, such as on an email, webpage, etc. However, the security seal in the present disclosure is physically printed on a print medium.

### Authentication System

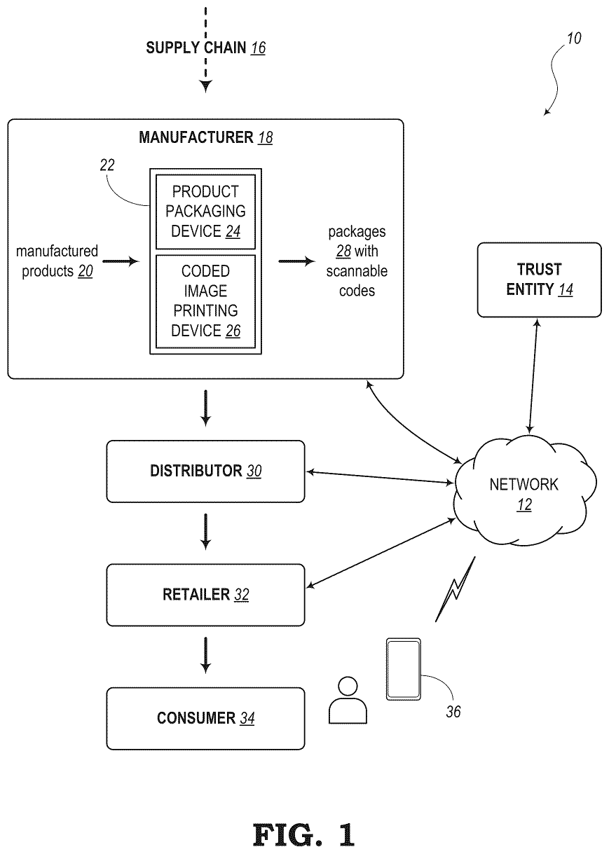

FIG. 1 is a diagram illustrating an embodiment of a product authentication system 10, which involves communication via a network 12. A trust entity 14 (e.g., CA) may be configured to provide various security and trust services, such as issuing digital certificates and security seals to various organizations (e.g., companies, manufacturers, universities, enterprises, etc.). As shown in FIG. 1, the product authentication system 10 further includes a supply chain 16, which may include, among other parties, a manufacturer 18 (e.g., producer), a distributor 30 (e.g., supplier, wholesaler, vendor, etc.), a retailer 32 (e.g., merchant, store, etc.), and a consumer 34 (e.g., customer, purchaser, etc.). The consumer 34 may use a user device 36 (e.g., mobile phone) to communicate to the trust entity 14 via the network 12 for the purpose of verifying the authenticity of purchased products.

The manufacturer 18 is configured to produce manufactured products 20 (e.g., pharmaceuticals, electronics, luxury items, watches, jewelry, cosmetics, machine parts, foods, toys, video games, software, household appliances, sporting goods, or any other type of goods. Next, the manufacturer 18 is configured to send the manufactured products 20 to a packaging station 22. For example, the packaging station 22 not only includes a product packaging device 24 for protecting the manufactured products 20 by placing the products in suitable packages, but also includes a coded image printing device 26. The coded image printing device 26 is configured to print a coded security seal on a physical print medium associated with the packaging. Thus, the manufacturer 18 is configured to produce packages 28 of products, where the packages 28 have scannable codes that can be used for the verification of the authenticity of the products.

For example, the coded security seal may be printed directly on the outer surface of the packages 28 or on labels that are attached to the outer surface. In some embodiments, however, the print medium may be a piece of paper, cardboard, or the like, which may then be placed inside the packages 28 before they are closed and sealed. As explained in more detail below, the security seal may be scanned to obtain encrypted information that can thereby be used to verify that the manufactured products 20 are authentic and not counterfeit. The security seal may be printed along with instructions to prompt the user or users to scan the security seal (e.g., with dedicated scanning equipment and/or apps) for verifying authenticity. By placing the printed security seal on the outside of the package 28, the consumer 34 can verify authenticity before opening the package 28. By placing the printed security seal inside the package 28, the consumer 34 may need to open the package to see the security seal.

Again, the security seal may be printed directed on an outer surface of a package that is designed to protect the product during transport throughout the supply chain 16. According to one example, the manufacturer 18 may be a pharmaceutical company that produces medicines in any suitable form, such as pills, capsules, tablets, etc. A first layer of packaging may include the placement of the pills inside a bottle with a safety cap or placement of the pills in a blister pack which are then placed in a small box. A security seal intended for use by the consumer 34 may be placed on or inside this first layer of packaging. A second layer of packaging may include placing multiple bottles or boxes of pills in a larger box or package. A second security seal may be placed on or inside this second layer of packaging and may be intended for use by the distributor 30 or retailer 32, depending on how the bottles or boxes are shipped. A third layer of packaging may include a crate of boxes, which may be shipped from the manufacturer 18 to the distributor 30. Again, a third security seal may be placed on or inside this third layer and may be used by the distributor 30 for verification. In this way, there may be multiple layers of packaging, intended for different parties in the supply chain 16, where each can scan the associated security seal and verify that the pills are authentic. It should be noted that, in addition to the pharmaceutical example, the same process can be used for other types of manufactured products 20.

According to a first implementation, the user device 36 may be configured to download an app from the trusted entity 14. In this case, the app may be configured to enable the user to scan the coded security seal (e.g., using a camera on the user device 36). The app may include features that allow the user device 36 to decode some or all portions of encrypted information included in the security seal. The decoded information can be analyzed to determine whether a purchased product is authentic or counterfeit. In other embodiments, the user device 36 may be configured to send some or all of the captured image information to the trust entity 14, which may then perform the product authentication procedure. In still other embodiments, both the user device 36 and trust entity 14 may perform coordinated functions for image analysis, decoding, and verification to determine if the security seal identifies the purchased product as legit or counterfeit.

In some embodiments, as suggested above, the verification of product authentication may involve multiple steps along the supply chain 16 to ensure that the manufactured products 20 are authentic at each stage. Therefore, when the distributor 30 receives packaged products 28 (with scannable codes) from the manufacturer 18, the distributor 30 can scan the security seal to check authenticity. Also, the retailer 32, upon receiving the packaged products 28 from the distributor 30, can span the same or a different security seal to ensure authenticity. Finally, the consumer 34 can also check that the packaged products 28 are authentic (e.g., before consuming the product). By checking at each stage, it may be easier to pinpoint where counterfeit products (if any) may have been introduced.

### Examples of Printed Security Seals

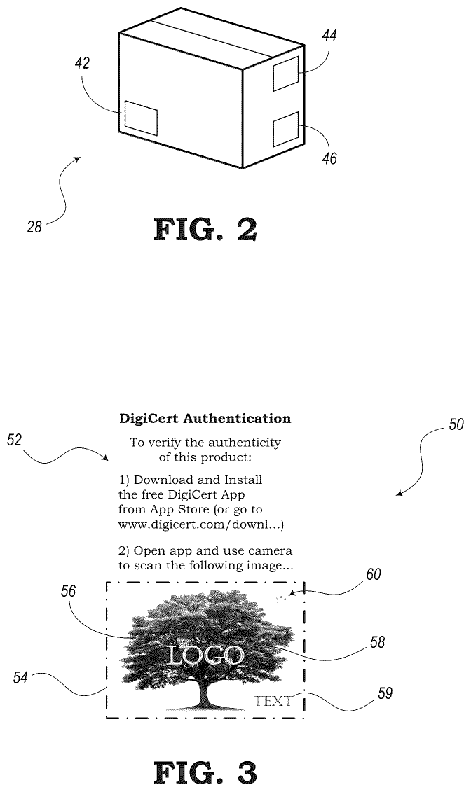

FIG. 2 is an isometric view showing an example of a package 28 that protects a manufactured product (e.g., manufactured product 20 shown in FIG. 1). The package 28 may include any number of security seals or other codes (e.g., barcodes, QR codes, etc.) As shown in this embodiments, the package 28 may include a first seal 42, a second seal 44, and a third seal 46, positioned at different locations on the outer surface of the package 28. According to one embodiment, the first seal 42 may be used by the distributor 30 for performing a first authentication test, the second seal 44 may be used by the retailer 32 for performing a second authentication test, and the third seal 46 may be used by the consumer 34 for performing a third authentication test. According to another embodiment, one or two of the seals 42, 44, 46 may be decoy seals that point to a generic URL and are not intended to provide any useful information, while the remaining seals may be used for verification purposes by one or more of the distributor 30, retailer 32, and/or consumer 34. As suggested above, another embodiment may include placing the multiple seals 42, 44, 46 on one more different layers of packaging for use by one or more of the distributor 30, retailer 32, and/or consumer 34.

FIG. 3 is a diagram illustrating an example of a printed security seal 50 associated with a package (e.g., package 28). As shown, the printed security seal 50 of FIG. 3 includes user instructions 52 that are configured to guide the user through the authentication process. In this example, the trust entity 14 may be DigiCert, the Assignee of the present application. The instruction 52 in this case may define a “DigiCert Authentication” procedure to allow the user to verify the authenticity of the product. For example, the instructions may prompt the user to download an app (from an app store or from a website) to the user device 36 (e.g., mobile phone).

Furthermore, the printed security seal 50 may include a border 54 in which an image 56 (e.g., tree) and/or logo 58 may be visible. Within the border 54, the printed security seal 50 may also include additional text 59. Also, in some embodiments, the printed security seal 50 may include markings 60, which may appear as noise, scratches, etc., but are actually produced intentionally. The markings 60 may include nearly imperceptible objects (e.g., squares, triangles, circles, lines, etc.), etc., which may be reduced to pixel-level images. In addition, the printed security seal 50 may include visible elements/attributes and/or hidden elements/attributes. The visible elements can be seen in FIG. 3, but may also include other objects, such as holographic elements. Also, the printed security seal 50 may include depth features that may not be recognizable by casual observation by a human, but can include elements that can be detected by using a depth sensor to create a depth map having line or image that appear when the depth sensor is held in a specific position from the printed security seal 50. In addition, the printed security seal 50 may include hidden attributes, such as steganographic elements, which can be decrypted using computer imaging processes.

The app installed on the user device 36 can be used to capture an image that includes any one or more of the border 54, image 56, logo 58, text 59, and markings 60, according to various implementations. The app may be configured to capture more than a typical camera may capture. In some embodiments, the app may be configured to perform certain image processing steps to decode the encoded information stored in the printed security seal 50. The encoded information, for instance, may include manufacturing information (e.g., manufacturer name, date of manufacture, manufacturer's location, product information, expiration date, etc.). Some of this information can be used to verify authenticity.

Furthermore, the app may be configured to capture an image of the printed security seal 50 and then pass the image to the trust entity 14, which can then perform a greater level of authenticity analysis. The information encoded in the printed security seal 50 can be decoded by the trust entity 14. In this case, the encoded information may include a nonce (number used only once), that can be added to each package 28. The trust entity 14 may keep a record of all the nonces from scanned images by a plurality of manufacturers, distributors, retailers, and consumers. If it is found that a nonce has already be decoded (and recorded), the trust entity 14 can perform a record and replay procedure, whereby the replaying the same (recorded) nonce is an indication that this nonce has already been used (likely by a counterfeiter who reproduces the same encoded information) and is therefore likely to be a counterfeit. If it is found to be used only once, then the trust entity 14 may indicate to the consumer 34 that the product is authentic (or is not detected as being a counterfeit).

The systems and methods of the present disclosure are configured to provide various security and authentication benefits, which may be summarized as follows:
I. Introduction: The rise of counterfeit pharmaceuticals presents challenges to consumer safety, healthcare systems, and financial losses. Solutions incorporating holograms, barcodes, and QR codes are introduced to empower consumers and create a secure product authentication process.
II. Product Authentication Measures: Each product can be marked with a hologram or barcode, offering dual benefits of enhanced security against counterfeiting and a straightforward verification method for consumers.
III. Comprehensive Product Information: Scanning the hologram or barcode provides consumers with detailed product information, including manufacture date, batch number, expiration date, serial number, model number, warranty details, and more.
IV. Registration with the Trust Entity (e.g., DigiCert): Manufacturers can register with the trust entity 14, DigiCert, or other recognized Certificate Authority (CA), to print issued certificates in the form of holograms on their products, establishing a trusted link between the product and its manufacturer.
V. Verification Process for Consumers: Consumers use dedicated scanners to verify product authenticity, decoding hologram or barcode information to distinguish genuine from counterfeit products.
VI. Example Use Case: The pharmaceutical industry faces challenges in drug safety and counterfeit circulation. Pharmaceutical companies can adopt the multi-tiered trust and authentication system, as described herein, to prevent unauthorized drugs from entering the market.
VII. Multi-Level Trust (CA) Hierarchy: Digi Root CA can be configured as a top-level trust anchor. International Drug Safety Root can ensure international compliance and safety standards. National Drug Safety Root can tailor standards to national regulations. Pharma Company CA can certify specific companies under the national root. Manufacturer CA can certify individual manufacturers under a pharmaceutical company. Drug SKU can assign a unique identifier to each specific drug, tying it to manufacturing origin and safety certifications.
VIII. Real-Time Etching of QR/Barcode Certificates: Ensures tamper-resistant, easily scannable codes on drug packaging with critical information and certifications.
IX. Revocation Capability: Allows immediate revocation of SKUs or CAs in case of bans or non-compliance, ensuring swift identification and removal of compromised or unsafe products.
X. Consumer Engagement: Success relies on consumer education, teaching them to scan and interpret QR/machine-readable codes for real-time verification of drug authenticity.
XI. Conclusion and Implementation Considerations: Implementing the systems and methods of the present disclosure in a specific industry (e.g., the pharmaceutical industry) is a significant step in combating counterfeiting. The system's resilience against tampering and adaptability to changing regulations through certificate revocation offers a robust framework. However, successful implementation may rely on coordinated efforts in technology deployment, regulatory alignment, and consumer education to enhance global pharmaceutical safety standards. These concepts can be applied to any manufacturing industry.

### Trust Entity

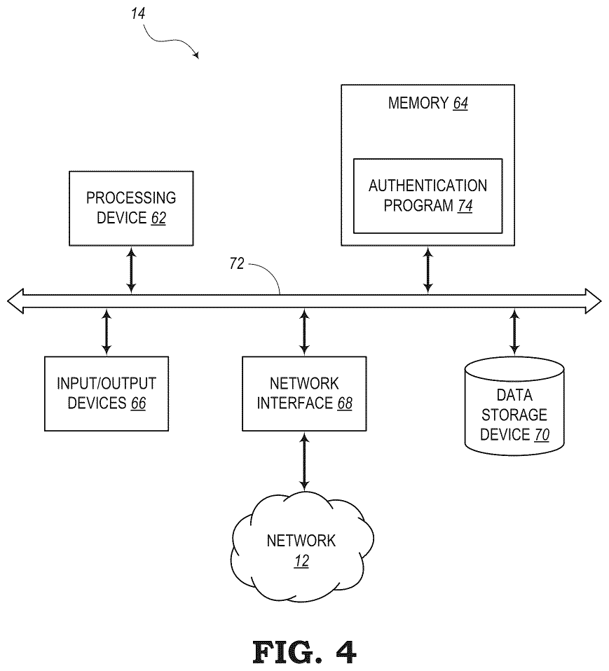

FIG. 4 is a block diagram illustrating computing components of an embodiment of the trust entity 14 shown in FIG. 1, where the computing components may represent a digital computer. In terms of hardware architecture, the trust entity 14 in this embodiment generally includes a processing device 62, memory 64, input/output (I/O) devices 66, a network interface 68, and a data storage device 70. It should be appreciated by those of ordinary skill in the art that FIG. 4 depicts the trust entity 14 in an oversimplified manner, and a practical embodiment may include additional components and suitably configured processing logic to support known or conventional operating features that are not described in detail herein. The components (62, 64, 66, 68, 70) are communicatively coupled via a local interface 72. The local interface 72 may be, for example, but not limited to, one or more buses or other wired or wireless connections, as is known in the art. The local interface 72 may have additional elements, which are omitted for simplicity, such as controllers, buffers (caches), drivers, repeaters, and receivers, among many others, to enable communications. Further, the local interface 72 may include address, control, and/or data connections to enable appropriate communications among the aforementioned components.

The processing device 62 is a hardware device for executing software instructions. The processing device 62 may be any custom made or commercially available processor, a Central Processing Unit (CPU), an auxiliary processor among several processors associated with the trust entity 14, a semiconductor-based microprocessor (in the form of a microchip or chipset), or generally any device for executing software instructions. When the trust entity 14 is in operation, the processing device 62 is configured to execute software stored within the memory 64, to communicate data to and from the memory 64, and to generally control operations of the trust entity 14 pursuant to the software instructions. The I/O devices 66 may be used to receive user input from and/or for providing system output to one or more devices or components.

The network interface 68 may be used to enable the trust entity 14 to communicate on a network, such as the Internet. The network interface 68 may include, for example, an Ethernet card or adapter or a Wireless Local Area Network (WLAN) card or adapter. The network interface 68 may include address, control, and/or data connections to enable appropriate communications on the network. A data storage device 70 (e.g., one or more databases, data stores, etc.) may be used to store data. The data storage device 70 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage device 70 may incorporate electronic, magnetic, optical, and/or other types of storage media. In one example, the data storage device 70 may be located internal to the trust entity 14, such as, for example, an internal hard drive connected to the local interface 72 in the trust entity 14. Additionally, in another embodiment, the data storage device 70 may be located external to the trust entity 14 such as, for example, an external hard drive connected to the I/O devices 66 (e.g., SCSI or USB connection). In a further embodiment, the data storage device 70 may be connected to the trust entity 14 through a network, such as, for example, a network-attached file server.

The memory 64 may include volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 64 may incorporate electronic, magnetic, optical, and/or other types of storage media. Note that the memory 64 may have a distributed architecture, where various components are situated remotely from one another but can be accessed by the processing device 62. The software in memory 64 may include one or more software programs, each of which includes an ordered listing of executable instructions for implementing logical functions. The software in the memory 64 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The trust entity 14 further includes an authentication program 74 that may be implemented in any suitable combination of hardware (e.g., configured in the processing device 62) and/or software/firmware (e.g., configured in the memory 64). The authentication program 74 may be stored in any suitable non-transitory computer-readable media (e.g., the memory 64) and may include computer logic or code having instructions that enable or cause the processing device 62 to perform certain actions as discussed in the present disclosure.

The authentication program 74 may include multiple functions for implementing the verification of product authenticity throughout the supply chain 16. First, the authentication program 74 may be configured to download versions of an app or Software Development Kit (SDK) to the user device 36. Other versions may be downloaded to the distributor 30, retailer 32, and any other entity between the manufacturer 18 and consumer 34 who may wish to check that counterfeit products have been introduced into the supply chain 16. Each app or SDK may be configured to lead a user through various steps, such as using a camera, scanner, or other device for scanning one or more security seals or codes according to a specific plan. The apps and SDKs may decode certain elements of the scanned images and may pass images to the trust entity 14 for further review.

The authentication program 74 may also be configured to receive scanned images from the remotely operated apps and SDKs and decode information that was encoded therein. Again, encoded information may include manufacturing information, product information, etc., as well as other information used for security, such as a randomly generated and non-repeatable nonce. In some embodiments, encryption may be used to create and forward blockchain information as the package is transported through the supply chain 16.

Of note, the general architecture of the trust entity 14 can define any device described herein. However, the computing components of the trust entity 14 are merely presented as an example architecture for illustration purposes. Other physical embodiments are contemplated, including virtual machines (VM), software containers, appliances, network devices, and the like.

In an embodiment, the various techniques described herein can be implemented via a cloud service. For example, the trust entity 14 may be implemented in the cloud. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

### User Device With SDK

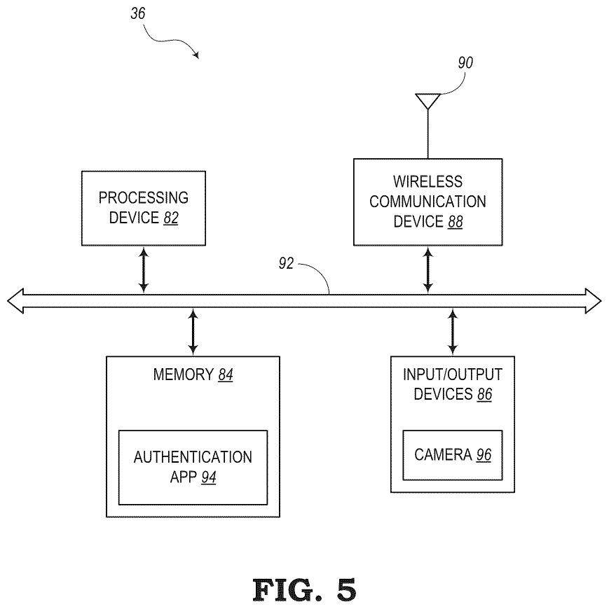

FIG. 5 is a block diagram illustrating computing components of an embodiment of the user device 36 shown in FIG. 1. The computing components of the user device 36 may be the same or similar to the computing components of the trust entity 14. However, in some embodiments, the user device 36 may be arranged as a mobile phone, smart phone, or the like, which can be maneuvered easily for capturing images and may include wireless (e.g., cellular, Wi-Fi, Bluetooth, etc.) capabilities.

As shown in FIG. 5, the user device 36 may include a processing device 82, a memory 84, I/O devices 86, and a wireless communication device 88 with an antenna 90. It should be appreciated by those of ordinary skill in the art that FIG. 5 depicts the user device 36 in an oversimplified manner, and a practical embodiment may include additional components and suitably configured processing logic to support known or conventional operating features that are not described in detail herein. The components (82, 84, 86, 88) are communicatively coupled via a local interface 92. The local interface 92 may be, for example, but not limited to, one or more buses or other wired or wireless connections, as is known in the art. The local interface 92 may have additional elements, which are omitted for simplicity, such as controllers, buffers (caches), drivers, repeaters, and receivers, among many others, to enable communications. Further, the local interface 92 may include address, control, and/or data connections to enable appropriate communications among the aforementioned components.

The processing device 82 is a hardware device for executing software instructions. The processing device 82 may be any custom made or commercially available processor, a CPU, an auxiliary processor among several processors associated with the user device 36, a semiconductor-based microprocessor (in the form of a microchip or chipset), or generally any device for executing software instructions. When the user device 36 is in operation, the processing device 82 is configured to execute software stored within the memory 84, to communicate data to and from the memory 84, and to generally control operations of the user device 36 pursuant to the software instructions. The I/O devices 86 may be used to receive user input from and/or for providing system output to one or more devices or components. The wireless communication device 88 may be used to enable the user device 36 to communicate on a cellular network or other type of network, such as the Internet. The I/O devices 86 may include a camera 96 or other type of image capture device for scanning security seals, barcodes, QR codes, etc., which may include visible attributes and hidden attributes.

The memory 84 may include volatile memory elements (e.g., RAM, DRAM, SRAM, SDRAM, etc.), nonvolatile memory elements (e.g., ROM, hard drive, tape, CDROM, etc.), and combinations thereof. Moreover, the memory 84 may incorporate electronic, magnetic, optical, and/or other types of storage media. Note that the memory 84 may have a distributed architecture, where various components are situated remotely from one another but can be accessed by the processing device 82. The software in memory 84 may include one or more software programs, each of which includes an ordered listing of executable instructions for implementing logical functions. The software in the memory 84 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The user device 36 further includes an authentication app 94 (e.g., API, SDK, etc.) that may be implemented in any suitable combination of hardware (e.g., configured in the processing device 82) and/or software/firmware (e.g., configured in the memory 84). The authentication app 94 may be stored in any suitable non-transitory computer-readable media (e.g., the memory 84) and may include computer logic or code having instructions that enable or cause the processing device 82 to perform certain actions as discussed in the present disclosure. The authentication app 94 may be configured to operation in conjunction with the authentication program 74 of the trust entity 14 for performing multiple functions for verifying the authenticity of manufactured products.

Therefore, the embodiments of the present disclosure are configured to address the issue of counterfeiting. The systems and methods may include a comprehensive authentication system utilizing holograms, steganographic elements, barcodes, advanced QR codes, etc., which may include a combination of visible attributes and hidden attributes. The systems and methods enhance product security, provide transparency, and establish a multi-tiered trust hierarchy from the international to the individual drug level.

### Process for Verifying Authenticity of Packaged Product

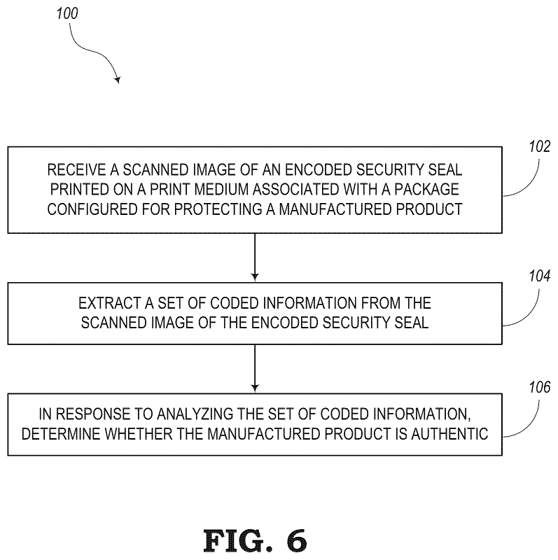

FIG. 6 is a flow diagram illustrating an embodiment of a method 100 for verifying the authenticity of a manufactured product. In some embodiments, the method 100 may be associated with functionality of the trust entity 14. According to other embodiments, the method 100 may be implemented by two components of the product authentication system 10, such as the user device 36 and the trust entity 14. In still other embodiments, the method 100 may be implemented by multiple components of the product authentication system 10, such as the manufacturer 18, distributor 30, retailer 32, and user device 36 in coordination with the trust entity 14. The method 100 may be performed by any system (e.g., trust entity 14, manufacturer 18, distributor 30, retailer 32, and user device 36) having a processing device, memory, and authentication software, whereby the software may be configured with logical instructions that enable the processing device to perform certain tasks.

As shown in FIG. 6, the method 100 includes a step receiving a scanned image of an encoded security seal printed on a print medium associated with a package configured for protecting a manufactured product, as indicated in block 102. Also, the method 100 includes a step of extracting a set of coded information from the scanned image of the encoded security seal, as indicated in block 104. In response to analyzing the set of coded information, the method 100 further includes a step of determining whether the manufactured product is authentic, as indicated in block 106.

In some embodiments, the encoded security seal may include one or more visible attributes and one or more hidden attributes. The step of extracting the set of coded information (block 104) may include obtaining the set of coded information from at least the one or more hidden attributes. The one or more hidden attributes may include a) a set of angles associated with lines or text in the visible attributes, b) a depth map obtained by a depth sensor, and/or c) three dimensional system placement features. In some cases, the one or more hidden attributes may include a hologram and/or a steganographic image. The one or more visible attributes may include added or manipulated pixels and/or imperfections in one or more of an image, logo, text, and border associated with the visible attributes. The one or more visible attributes may further include arbitrary noise intended to deceive a counterfeiter. The one or more visible attributes may include a barcode or QR code configured to reference a trusted web address. The one or more hidden attributes may be hidden within the barcode or QR code.

According to some implementations, the scanned image may be obtained by a camera of a user device associated with a consumer who has purchased the manufactured product. The step of receiving the scanned image (block 102) may be performed by a trust entity in communication with the user device. The user device may be a mobile device, wherein an app or Software Development Kit (SDK) running on the mobile device may be configured to perform the steps of receiving, extracting, and determining.

The scanned image, for example, may be obtained by a device associated with a distributor or retailer in a supply chain between a manufacturer of the manufactured product and a consumer of the manufactured product. The method 100 may further include a step of storing one or more sets of encoded information in a blockchain format and determine authenticity of the product throughout the supply chain. The method 100 may also record multiple sets of coded information extracted from scanned images of multiple encoded security seals printed in association with multiple packages, wherein each set of coded information includes a non-repeatable nonce. Also, determining that the manufactured product is authentic may include observing that the respective non-repeatable nonce has not been previously replayed.

In response to determining whether the manufactured product is authentic (block 106), the method 100 may further include a step of providing an indication to a consumer of the manufactured product as to whether the manufactured product is authentic or counterfeit. The print medium, for instance, may be a) an outer surface of the package and/or b) a label attached to the outer surface of the package. Alternatively, the print medium may be a) a piece of paper or card placed inside the package during manufacturing and/or b) an inside surface of the package.

The set of coded information (block 104) may include one or more of validity information, manufacturer information, manufacturing date, manufacturing location, product information, product serial number, product expiration date, and expiration date of a certificate associated with the manufacturer or product. The set of coded information may also include encrypted information using Rivest-Shamir-Adleman (RSA) cryptography. The product, for example, may include pharmaceuticals, packaged food, electronics, luxury items, watches, jewelry, cosmetics, machine parts, software, video games, machine parts, household appliances, and/or sports equipment.

### Additional Considerations

To identify a single package or a single product, the product authentication system 10 may be configured to utilize nonce for each package or product. The nonce can be a one-time token. Every time a new security seal is printed, a new nonce can be generated and encoded in the encryption information that can be extracted using an authorized app. The nonce is a unique number that only could be used once for every package, box, product, etc. When the user scans the security seal and uncovers the nonce, this results in marking the nonce as already having been scanned and recorded. Multiple nonces may be intended for each stage of the supply chain, where each authorized party is responsible for scanning the security seal once for their corresponding nonce before passing the package to the next party in the supply chain.

If the security seal is scanned multiple times, the trust entity 14 can keep a record of that. If a counterfeiter tries to copy the security seal with a unique nonce associated therewith, then the trust entity 14 can detect that the nonce has been copied previously. In a digital world, this can be utilized in a system referred to as record and replay. The trust entity 14 can go ahead and record a specific transaction and then replay it, and if it replays it a second time, it will know that it has already seen it. It can be marked as expired, because the nonce has already been seen. Also, the trust entity 14 can notify the party that the product (or at least the security seal) is counterfeit.

In some embodiments, there may be a publicly accessible blockchain network that can open a blockchain file and add additional information in a secure way, where the history of the opening, editing, and saving can be recorded in an unchangeable manner. The blockchain file can be passed along the supply chain to include a history of authentication checks. The next party in line can look up how many times the specific product has been scanned and by whom. It can tell where the nonce was generated, whether it was generated with a legitimate manufacturer (e.g., Johnson and Johnson) in a known location (e.g., JnJ in Wyoming), that it was passed along to a recognized distributor, and then went to the legitimate pharmacy. Then, the consumer, who actually purchases the medication at the end of the cycle can see the history from the blockchain information.

The nonce may be generated by the manufacturer 18 and printed directed on the packaging. Alternatively, the nonce may be generated by the trust entity 14 and printed on labels that are shipped to the manufacturer 18 or the generated nonces may be forwarded to the manufacturer 18 for printing. The nonce include a random sequence of numbers and may include a certain number of digits (e.g., about 20 digits). The nonces are non-repeatable.

The trust entity 14 can generate the nonce and hand the nonce over to whomever requests it (e.g., a specific manufacturer). Thus, the trust entity 14 acts as a proofer. Then, for recording and analyzing nonce, the trust entity 14 acts as a verifier. The trust entity 14 can provide a specific SDK or application that users can install on their phones. In some cases, as part of SDK (e.g., associated with Johnson and Johnson, CVS, Walgreens, etc.), each manufacturer, distributor, or retailer can have their own SDK or app that enables them to look for specific nonces whenever they receive a product, and they will scan the product with the SDK.

As part of the print process, the trust entity 14 may be configured to provide a set of instructions that enables the manufacturer to print the labels corresponding to the acceptable security seal. The security seal is not necessarily a label of a barcode or QR code, although in some cases it may be. The security seal may include an image or a logo. In some cases, it may be part of a print of text, blank space, box, or other area on a label or package, which may not be visible to the naked eye. Instead, the relevant information regarding authentication and information associated with manufacturing can be embedded or incorporated inside the printed text, blank space, box, etc., which may only be readable by the dedicated SDK.

The packaging may include a QR code, which may be used for normal reference to a web page. However, in some cases, the QR code may further include intentional markings or “imperfections” that are encoded with a particular meaning that can only be interpreted by the SDK. The QR code can also be used for the sake of tracking the package along the supply chain, but may also include hidden information that can be used for the sake of detecting counterfeits.

The SDK may be configured to look for features or hidden attributes that may not be noticeable or which may be encoded using hologram or steganographic element. The security seal may be designed to have an ordinary appearance, but the SDK may be designed to look for information at a certain location on the package or within an image and thereby extract the information. Without the SDK, the user may use their device to hover the camera over the image, but it might pick up nothing. However, with the SDK, if the user hovers their phone camera over the image, the app can look for those specific attributes in that printed box, blank space, text, etc.

For example, in some cases, the SDK may look at the angles in the font of specific text or look for specific pixels in specific places. It could potentially look for and use an in depth analysis (depth sensor) of the camera in order to obtain a depth or depth map of a picture that has been printed. It could look for tiny shapes (e.g., triangles, square, circles, etc.), or three dimensional system placement, where someone might imagine is simply imperfections, pixels that have been dropped, or a bad print, whereas, according to these embodiments, it is actually information. The selection of this information may then lead to a URL or include other useful information for detecting product authenticity.

For instance, the SDK may utilize a depth sensor in a camera that measures the distance between the camera and various objects in a scene. It can provide information about the depth or distance of different elements in the image, allowing the camera to create a depth map, which may be a representation of the spatial arrangement of objects in the scene, with each pixel assigned a corresponding depth value.

A CA (e.g., DigiCert) or trust entity 14 can provide different types of certificates. Also, the CA can be a top level trust actor. From there, there may be multiple other levels of CA involvement. This may include international or relational levels that have various roots. Each individual company (e.g., manufacturers, retailers, etc.) can have its own CA, which comes under a national route and manufacture CAs, which may be under a pharmaceutical company. Under this level of the structure of a certificate chain, there may be pharmacies. The system can identify each specific drug being manufactured, the origin and safety certificates of these, etc.

Regarding security and trust, the systems of the present disclosure may follow a chain of trust, where the trust entity 14 may be configured as the top root and can provide information to the manufacturer, and then one or more Intermediate Certificate Authorities (ICAs) could be the manufacturer 18 and/or distributor 30. The manufacturer may sign the scan data with their representative information, which in this case may be their respective ICA. Then, the manufacturer can put that data on a blockchain file. Then, when this item goes to the distributor, the distributor will scan it with their own ICA, and so on. The certificate aspect of this system provides the chain of trust, where the chain of custody is known, which is a derivative of chain of trust. As the package is scanned while passing along the supply chain, every time it is scanned this, the party signs it with their certificate in order to ensure that the next in line will know that the product is associated with the right authority.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A system comprising:
a processing device; and
memory configured to store an authentication program having logical instructions that, when executed, enable the processing device to
receive a scanned image of an encoded security seal printed on a print medium associated with a package configured for protecting a manufactured product,
extract a set of coded information from the scanned image of the encoded security seal, and
in response to analyzing the set of coded information, determine whether the manufactured product is authentic.

2. The system of claim 1, wherein the encoded security seal includes one or more visible attributes and one or more hidden attributes, and wherein extracting the set of coded information includes obtaining the set of coded information from at least the one or more hidden attributes.

3. The system of claim 2, wherein the one or more hidden attributes include one or more of a) a set of angles associated with lines or text in the one or more visible attributes, b) a depth map obtained by a depth sensor, and c) three dimensional system placement features.

4. The system of claim 2, wherein the one or more hidden attributes include one or more of a hologram and a steganographic image.

5. The system of claim 2, wherein the one or more visible attributes include added or manipulated pixels and/or imperfections in one or more of an image, logo, text, and border associated with the one or more visible attributes.

6. The system of claim 5, wherein the one or more visible attributes further include arbitrary noise intended to deceive a counterfeiter.

7. The system of claim 2, wherein the one or more visible attributes include a barcode or QR code configured to reference a trusted web address.

8. The system of claim 7, wherein the one or more hidden attributes are hidden within the barcode or QR code.

9. The system of claim 1, wherein the scanned image is obtained by a camera of a user device associated with a consumer who has purchased the manufactured product.

10. The system of claim 9, wherein receiving the scanned image is performed by a trust entity in communication with the user device.

11. The system of claim 9, wherein the user device is a mobile device, and wherein receiving, extracting, and determining are performed by an app or Software Development Kit (SDK) running on the mobile device.

12. The system of claim 1, wherein the scanned image is obtained by a device associated with a distributor or retailer in a supply chain between a manufacturer of the manufactured product and a consumer of the manufactured product.

13. The system of claim 12, wherein the logical instructions further enable the processing device to store one or more sets of encoded information in a blockchain format and determine authenticity of the manufactured product throughout the supply chain.

14. The system of claim 1, wherein the logical instructions further enable the processing device to record multiple sets of coded information extracted from scanned images of multiple encoded security seals printed in association with multiple packages, wherein each set of coded information includes a non-repeatable nonce, and wherein determining that the manufactured product is authentic includes observing that the respective non-repeatable nonce has not been previously replayed.

15. The system of claim 1, wherein, in response to determining whether the manufactured product is authentic, the logical instructions further enable the processing device to provide an indication to a consumer of the manufactured product as to whether the manufactured product is authentic or counterfeit.

16. The system of claim 1, wherein the print medium is one or more of a) an outer surface of the package and b) a label attached to the outer surface of the package.

17. The system of claim 1, wherein the print medium is one or more of a) a piece of paper or card placed inside the package during manufacturing and b) an inside surface of the package.

18. The system of claim 1, wherein the set of coded information includes one or more of validity information, manufacturer information, manufacturing date, manufacturing location, product information, product serial number, product expiration date, and expiration date of a certificate associated with a manufacturer or product.

19. The system of claim 1, wherein the set of coded information includes encrypted information using Rivest-Shamir-Adleman (RSA) cryptography.

20. A method comprising steps of:
receiving a scanned image of an encoded security seal printed on a print medium associated with a package configured for protecting a manufactured product;
extracting a set of coded information from the scanned image of the encoded security seal; and
in response to analyzing the set of coded information, determining whether the manufactured product is authentic.
